(19) United States
(12) Patent Application Publication
(10) Pub. No.: US 2026/0249826 A1
(43) Pub. Date: Aug. 27, 2026

(54) SYSTEM AND METHOD FOR PARKING BRAKE DRAG MONITORING DIAGNOSTICS

(71) Applicant: HL MANDO CORPORATION, Gyeonggi-do (KR)

(72) Inventor: Jeremy DOBBS, Auburn, MI (US)

(21) Appl. No.: 19/064,945

(22) Filed: Feb. 27, 2025

(51) Int. Cl. B60T 13/74; B60T 17/22

(52) U.S. Cl. CPC B60T 13/741; B60T 17/221

(57) ABSTRACT

An electromechanical brake (EMB) system is provided. The EMB system includes: a brake rotor rotatable with a wheel of a vehicle; a brake pad assembly engageable with the brake rotor; an actuator assembly that includes an electric motor configured to mechanically move the brake pad assembly toward or away from the brake rotor; and an electronic control unit (ECU) coupled to the actuator assembly. The ECU includes a processor coupled to a memory that stores instructions that when executed by the processor causes the processor to perform operations for monitoring and controlling drag between the brake rotor and the brake pad assembly, and the operation include: obtaining, while the vehicle is in motion, a drag between the brake rotor and the brake pad assembly; and controlling the actuator assembly to adjust a position of the brake pad assembly, relative to the brake rotor, based on the drag.

### BACKGROUND

Various embodiments of the present disclosure generally relate to an electromechanical brake system and more particularly to a system and method for monitoring, diagnosing, and controlling a parking brake of the electromechanical brake system.

A brake system for a motor vehicle, and in particular an automotive vehicle, functionally reduces the speed of the vehicle or maintains the vehicle in a rest position. Various types of brake systems are commonly used in automotive vehicles, including hydraulic, anti-lock or “ABS,” electromechanical brake (EMB) systems, and electric or “brake by wire.”

For example, in a hydraulic brake system, the hydraulic fluid transfers energy from a brake pedal to a brake pad for slowing down or stopping rotation of a wheel of the vehicle. In an electric brake system, the application and release of the brake is controlled by an electric caliper via electrical signal. The electric brake system typically includes an electric actuator connected to a brake caliper either by a cable, as the drum in head, or directly attached to the brake caliper. The electric actuator converts electrical power to rotational mechanical output power for moving the cable or drive screw and applying the brakes.

### SUMMARY

The features and advantages of the present disclosure will be more readily understood and apparent from the following detailed description, which should be read in conjunction with the accompanying drawings, and from the claims which are appended to the end of the detailed description.

According to various embodiments of the present disclosure, an electromechanical brake (EMB) system may comprise: a brake rotor configured to be rotatable with a wheel of a vehicle; a brake pad assembly configured to be engageable with the brake rotor; an actuator assembly comprising an electric motor configured to mechanically move the brake pad assembly toward or away from the brake rotor; and an electronic control unit (ECU) coupled to the actuator assembly. The ECU is configured to mechanically control the actuator assembly and comprises a processor coupled to a memory that stores instructions that when executed by the processor causes the processor to perform operations for monitoring and controlling drag between the brake rotor and the brake pad assembly, and the operations comprising: obtaining, while the vehicle is in motion, a drag between the brake rotor and the brake pad assembly; and controlling the actuator assembly to adjust a position of the brake pad assembly, relative to the brake rotor, based on the drag.

The drag is based on a position control torque required for the electric motor to maintain a current position of the brake pad assembly relative to the brake rotor.

Obtaining the drag comprises: obtaining a position of the electric motor and an initial position offset of electric motor; and using the position of the electric motor and the initial position offset of electric motor to obtain an estimated linear position of the brake pad assembly.

Obtaining the drag further comprises: obtaining the position control torque using the estimated linear position of the brake pad assembly and a linear position reference value of the brake pad assembly.

The linear position reference value is preset by a manufacturer of the EMB system or by a driver of the vehicle.

Obtaining the position control torque using the estimated linear position and the linear position reference value comprises use of lash and friction compensation logic to determine a correlation between a torque applied on the electric motor and a wheel drag of the vehicle.

The estimated linear position of the brake pad assembly is further based on a drag position adjustment performed by the actuator assembly, the drag position adjustment being based on a previous adjustment of the position of the brake pad assembly based on a previously obtained instance of the drag by the ECU.

The position of the brake pad assembly, relative to the brake rotor, is adjusted to mitigate occurrence of thermal runaway when a brake caliper of the EMB system comprises high residual drag as a result of the brake pad assembly being in constant contact with the brake rotor.

Controlling the actuator assembly to adjust the position of the brake pad assembly based on the drag comprises: in a first instance where the drag violates a safety threshold, causing the EMB system to enter a safe state where the brake pad assembly is placed into a continuously open position; in a second instance where the drag exceeds a predetermined threshold that is lower than the safety threshold, causing the actuator assembly to increase a gap between the brake pad assembly and the brake rotor; and in a third instance where the drag is below the predetermined threshold, causing the actuator assembly to maintain a current position of the brake pad assembly relative to the brake rotor.

Controlling the actuator assembly to adjust the position of the brake pad assembly based on the drag comprises: determining that the drag is within a safe operating range but fails to meet a predetermined performance target of the EMB system; and causing the actuator assembly to increase a gap between the brake pad assembly and the brake rotor to eliminate the drag.

According to some embodiments of the present disclosure, a method for monitoring and controlling drag between a brake rotor and a brake pad assembly of an electromechanical brake (EMB) system is provided. The method is executed by an electric control unit (ECU) of the EMB system and comprises: obtaining, while the vehicle is in motion, a drag between the brake rotor and the brake pad assembly; and controlling the actuator assembly to adjust a position of the brake pad assembly, relative to the brake rotor, based on the drag. The brake rotor is configured to be rotatable with a wheel of a vehicle. The brake pad assembly is configured to be engageable with the brake rotor. The EMB system further comprises an actuator assembly comprising an electric motor configured to mechanically move the brake pad assembly toward or away from the brake rotor. The ECU is coupled to the actuator assembly to mechanically control the actuator assembly.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1 shows a cross-sectional view of a brake assembly according to an exemplary embodiment of the present disclosure.

FIG. 2A shows a data flow diagram of a method for monitoring and controlling drag between a brake rotor and a brake pad assembly of a brake assembly (e.g., an EMB system) according to an exemplary embodiment of the present disclosure.

FIGS. 2B-2C show implementation examples of drag between a brake rotor and a brake pad assembly of an EMB system according to an exemplary embodiment of the present disclosure.

FIGS. 3A-3B show flow charts for illustrating methods for monitoring and controlling drag between a brake rotor and a brake pad assembly of a brake assembly according to an exemplary embodiment of the present disclosure.

FIG. 4 shows a schematic view of a vehicle including a steering system and a brake assembly according to an exemplary embodiment of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

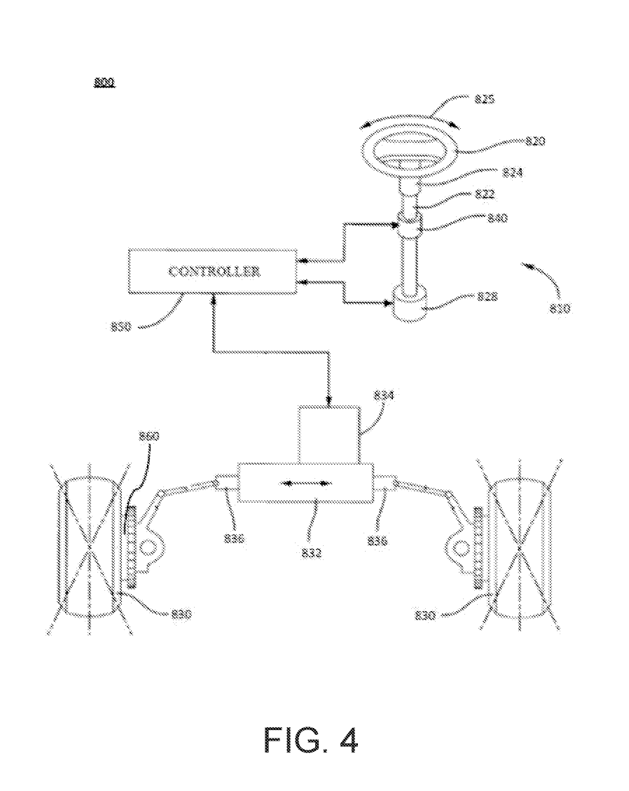

A vehicle (see, e.g., FIG. 4) may be equipped with one or more brake systems (e.g., an EMB system or the like) for slowing down or stopping rotation of a wheel of the vehicle (e.g., providing braking and stopping capabilities for vehicle). Due to their mechanical nature, such brake systems may produce drag (e.g., drag torque) when certain parts of the system that are not intended to come into contact do come into contact while the vehicle is still in motion and while the driver has not intended to apply any brake commands. Such drag may lead to potential failure of the brake system, resulting in dangerous conditions for the driver. Such drag may also cause a degradation in the fuel economy and performance of the vehicle.

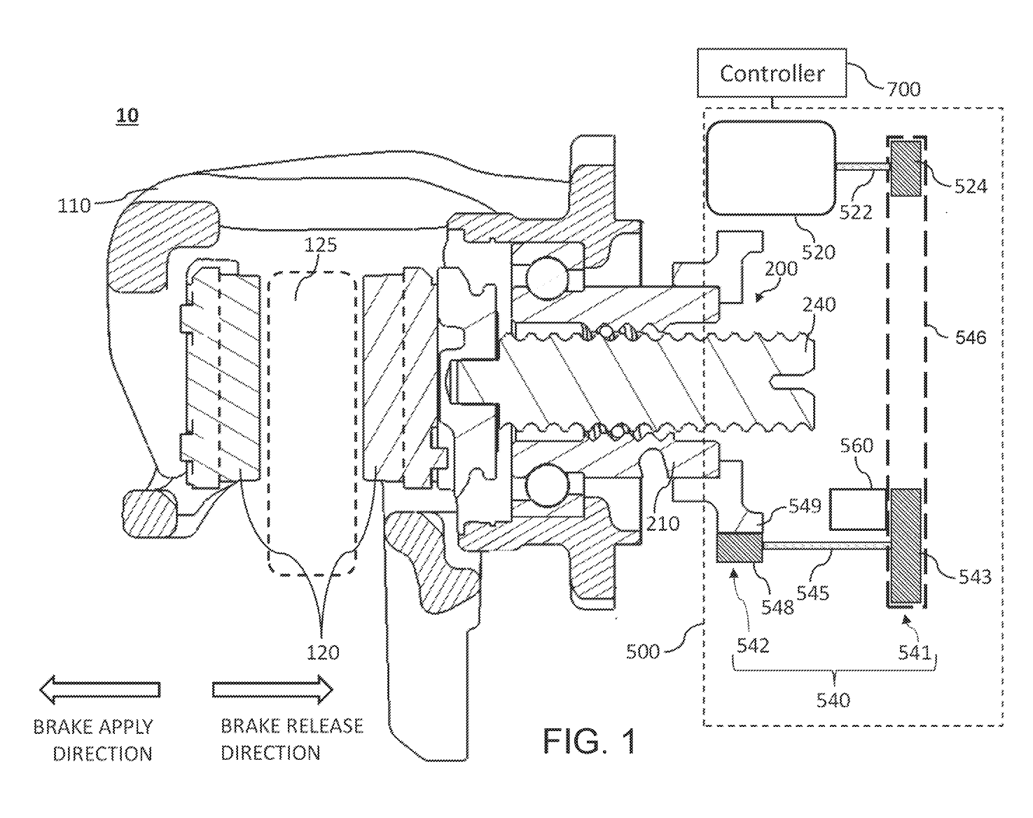

Referring to FIG. 1, a brake assembly 10 may include a brake caliper 110 mounted in a floating manner by means of a brake carrier. When the vehicle is in motion, a brake rotor 125 may rotate with a wheel about an axle of the vehicle. A brake pad assembly (or brake lining assembly) 120 (e.g., an electromechanical brake (EMB) system, or the like) is provided in the brake caliper 110. The brake caliper 110 may include a bridge with fingers, and the fingers of the brake caliper 110 may be in contact with the brake pad assembly 120. Each brake pad of the brake pad assembly 120 is disposed with a small air clearance on a side of the brake rotor 125, such as a brake disc, in a release position so that no significant residual drag moment occurs.

The brake assembly 10 may comprise a screw mechanism 200 (e.g., a ball screw mechanism or a nut-screw mechanism) configured to convert rotary motion generated by an actuator assembly 500 into linear motion in order to move the brake pad assembly 120 (namely, the right brake pad of the brake pad assembly 120) toward or away from the brake rotor 125 in an axial direction. The screw mechanism 200 may include a rotatable part 210 and a translatable part 240. For example, the rotatable part 210 may comprise a nut or a ball nut and the translatable part 240 may comprise a screw or a ball screw, although not required. The rotatable part 210 is operably coupled to the actuator assembly 500 and is configured to be rotatable by actuation of the actuator assembly 500.

The actuator assembly 500 may comprises the electric motor 520. For example, the electric motor 520 may be directly engaged with the rotatably part 210. Alternatively, the electric motor 520 is indirectly connected to the rotatably part 210 through means for transferring rotary force generated by the electric motor 520, such as one or more gears, one or more belts, one or more pulleys, and/or any other connecting means and combination thereof.

The actuator assembly 500 may have a multi-stage drive mechanism 540, although not required. The multi-stage drive mechanism 540 may be, for example, but is not limited to, a dual-stage drive mechanism comprising a belt drive mechanism 541 and a gear drive mechanism 542 to multiply torque from the electric motor 520 to supply rotary force to the rotatable body 210 of the drive mechanism 540. The belt drive mechanism 541 multiplies the torque from the electric motor 520 by using a drive pully 524 and a driven pulley 543 rotatably connected by a drive belt 546, and the torque multiplied by the belt drive mechanism 541 is delivered to the gear drive mechanism 542 through the intermediate shaft 545. The intermediate shaft 545 may connect the driven pulley 543 of the belt drive mechanism 541 to a first gear 548 of the gear drive mechanism 542 in order to deliver rotary torque, generated by the motor 520 and transmitted through the belt drive mechanism 541, to the gear drive mechanism 542. The first gear 548 is rotatably engaged with the second gear 549 to rotate the second gear 549 by the rotary torque transmitted through the intermediate shaft 545. The second gear 549 may be formed directly on a part of the circumferential surface of the rotatable body or nut 210 of the drive mechanism 540 or screw mechanism 200 or be mounted to the rotatable body 210 of the drive mechanism 540 to rotate the rotatable body or nut 210.

The mechanical connection between the electric motor 520 and the brake pad assembly 120 described above and illustrated in FIG. 1 is an example for illustration purposes only, and the present disclosure is not limited thereto. Any structure, configuration, and arrangement of the mechanical connection that can mechanically connect the electric motor 520 to the brake pad assembly 120 can be used.

Because the electric motor 520 and the brake pad assembly 120 are mechanically connected to each other, the movement of the brake pad assembly 120 (namely, movement in the right brake pad of the brake pad assembly 120) can cause the electric motor 520 to move. For instance, if the brake pad assembly 120 moves, a rotor of the electric motor 520 (e.g., the motor shaft 522) can rotate. Accordingly, if the brake pad assembly 120 moves in the brake release direction after the parking brake is applied, the displacement of the brake pad assembly 120 in the brake release direction can cause the rotor of the electric motor 520 (e.g., the motor shaft 522) to rotate due to the mechanical connection between the electric motor 520 and the brake pad assembly 120. As a result, a position of the electric motor 520 can be used to determine a linear position of the brake pad assembly 120, and vice versa.

To detect such changes in the linear position of the brake pad assembly 120, brake assembly 10 may further include a controller 700 that is able to measure a movement and/or position of the electric motor 520 (e.g., via one or more sensors not shown in FIG. 1) and a torque (e.g., motor torque) generated by the electric motor 520. The controller 700 may also be configured to control the electric motor 520 to perform braking operations of the brake assembly 10 (e.g., the above discussed movement of the translatable part 240 to cause the brake pad assembly 120 to engage with the brake rotor 125).

The controller 700 may also be configured to receive instructions (e.g., digital instructions) from a main computing system (e.g., via a serial connection bus such as a controller area network (CAN), bus or the like) of the vehicle to modify one or more parameters and/or capabilities of the brake assembly 10. The main computing system of the vehicle may be, for example, a chassis controller or the like.

The controller 700 may be, for example, but not limited to, a micro-controller unit (MCU), an electronic control unit (ECU), a circuit chip, a semiconductor circuit, and a circuit board having memory, one or more processors, and electric components. The controller 700 may be coupled to (e.g., one or more components of) the actuator assembly.

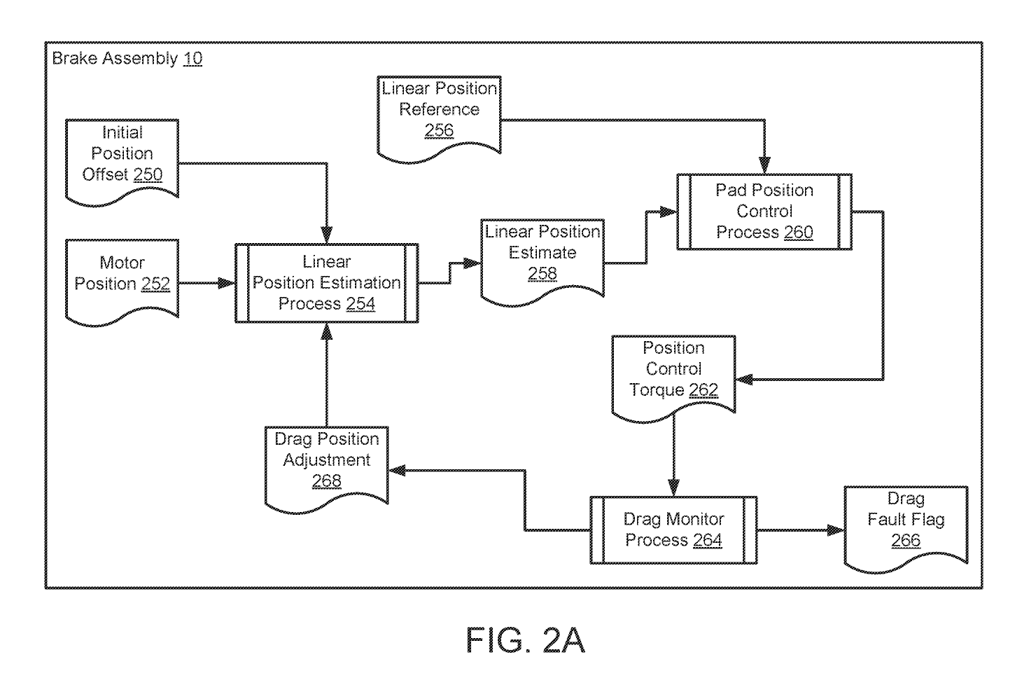

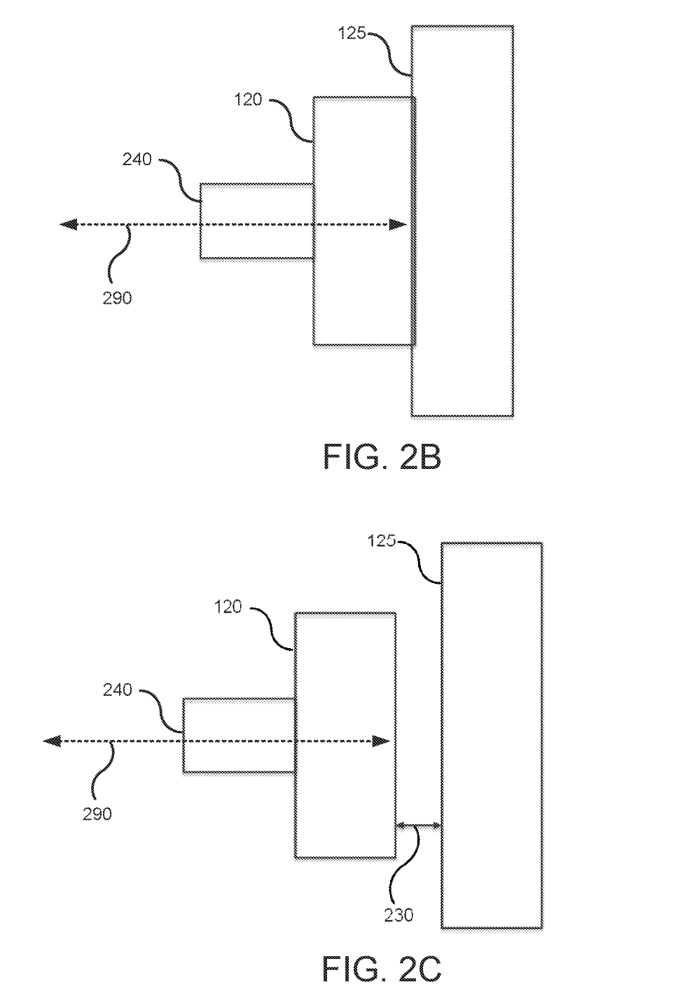

To illustrate how drag can occur within the brake assembly, FIG. 2B shows an implementation example of an exemplary embodiment of the present disclosure. In particular, FIG. 2B shows a simplified model showing contact between the brake pad assembly 120 (namely, the right brake pad of the brake pad assembly 120) and the brake rotor 125.

As shown in FIG. 2B, when the translatable part 240 moves in a linear direction 290, a linear position of the brake pad assembly 120 (along this linear direction 290) changes with such linear movement. Drag within the brake assembly 10 may occur when the brake pad assembly 120 comes into contact with and pushes against the brake rotor 125, as shown in FIG. 2B, while a braking command has not been received from the driver. Said another way, the linear position of brake pad assembly 120 has shifted enough in the linear direction 290 to cause the brake pad assembly 120 to interfere with the rotation of the brake rotor 125 during normal, non-braking, operation of the vehicle.

Such drag situation as shown in FIG. 2B causes a motor torque required to maintain the brake pad assembly 120 at a non-drag position to increase. Thermal runaway could occur when the brake caliper has high residual drag, resulting in partial or even complete failture of the brake assembly 10. Additionally, such drag (in low amounts) may also disadvantageously decrease the fuel economy of the vehicle as more rotation/acceleration of the wheel will be required to reach the speed (e.g., velocity) desired by the driver.

In embodiments, such increase in the motor torque may be detected by the controller 700 resulting in the controller 700 causing the electric motor 520 to move (e.g., perform a drag position adjustment to move) the brake pad assembly 120 away (in the linear direction 290) from the brake rotor 125 to create a position offset 230 (e.g., an air gap) between the brake pad assembly 120 and the brake rotor 125 as shown in FIG. 2C.

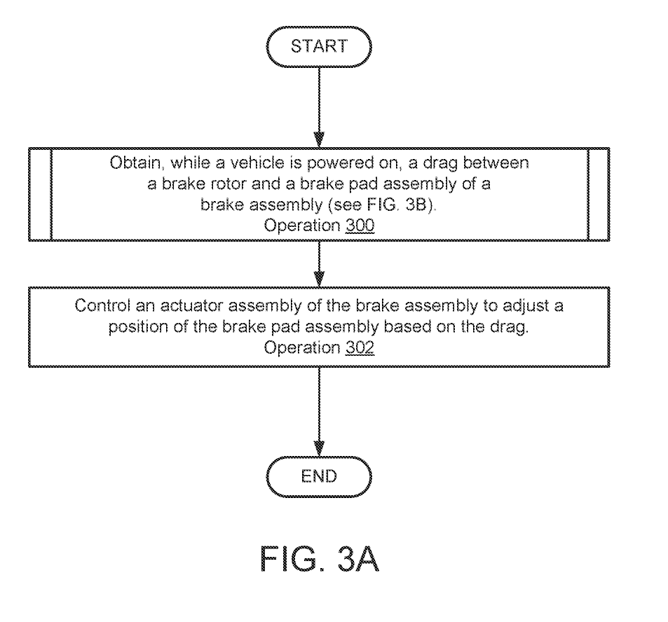

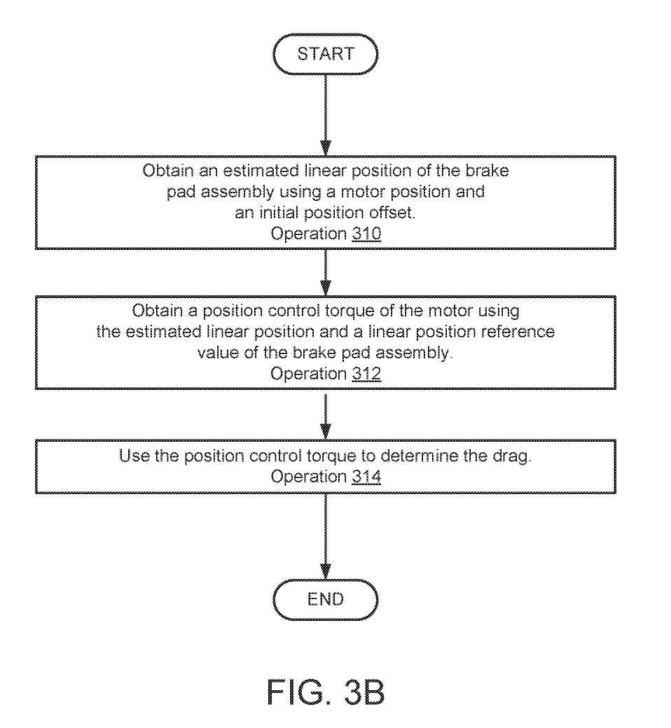

To measure such increase of motor torque, a method for monitoring and controlling drag between the brake rotor 125 and the brake pad assembly 120 of the brake assembly 10 (e.g., an EMB system) according to an exemplary embodiment of the present disclosure as discussed below in FIGS. 2A-3B may be applied.

Turning now to FIG. 2A, FIG. 2A shows a data flow diagram illustrating the method for monitoring and controlling drag between the brake rotor 125 and the brake pad assembly 120 of the brake assembly 10 (e.g., an EMB system) according to an exemplary embodiment of the present disclosure.

In this diagram, flows of data and processing of data are illustrated using different sets of shapes. A first set of shapes (e.g., 250, 252, 256, etc.) is used to represent data structures (e.g., files, documents, data packets, or the like), a second set of shapes (e.g., 254, 260, 264 etc.) is used to represent processes performed using and/or that generate data, and a third set of shapes (e.g., 10) is used to represent physical components that perform the processes depicted suing the second set of shapes. The data flow diagram of FIG. 2A may be performed by any of the computing-related/computing-enabled components (namely, controller 700 of brake assembly 10) shown in FIG. 1.

As shown in FIG. 2A, the controller 700 of brake assembly 10 may obtain an initial position offset 250 and a motor position 252. The initial position offset 250 may be a value representative of a linear position of the brake pad assembly 120 relative to the brake rotor 125 at a current point in time and/or current (e.g., real-time) operation of the vehicle. Said another way, the initial position offset 250 may be a current, real-time linear position of the brake pad assembly 120 at the time that controller 700 is determining whether any drag is being generated by the brake assembly 10.

The initial position offset 250 may be measured by controller 700 via, for example: one or more sensors installed within the brake assembly 10 to measure a physical position of the brake pad assembly 120 and/or the screw mechanism 250; or via conversion/calculation using other measured parameters and/or values of the actuator assembly 500 (e.g., motor torque, back electromotive force (back-EMF), and/or other parameters associated with the electric motor 520 and/or component(s) actuated by the electric motor 520, or the like), the brake pad assembly 120, and/or the screw mechanism 200 (e.g., gear ratio, lead angle of the ball of the ball and hitch assembly, or the like). In particular, any technique and/or method for determining a current linear position of the brake pad assembly 120 may be used without departing from the scope of embodiments disclosed herein.

The motor position 252 may be a current position of the electric motor 520. Similar to the initial position offset 250, the motor position 252 may be measured by the controller 700 via, for example: one or more sensors installed within the brake assembly 10 to measure a physical position of the electric motor 520; or via conversion/calculation using other measured parameters and/or values of the actuator assembly 500 (e.g., motor torque, back electromotive force (back-EMF), and/or other parameters associated with the electric motor 520 and/or component(s) actuated by the electric motor 520, or the like), the brake pad assembly 120, and/or the screw mechanism 200 (e.g., gear ratio, lead angle of the ball of the ball and hitch assembly, or the like). In particular, any technique and/or method for determining a current position of the electric motor 520 may be used without departing from the scope of embodiments disclosed herein.

As shown in FIG. 2A, the initial position offset 250 and motor position 252 may be ingested into linear position estimation process 254 to generate a linear position estimate 258 for the brake pad assembly 120. The linear position estimate 258 represents an estimated linear position of the brake pad assembly 120 as determined using the initial position offset 250 and motor position 252. In embodiments, linear position estimate 258 may be represented as estimated length of an air gap (e.g., air gap/ position offset 230 shown in FIG. 2C) between the brake pad assembly 120 and the brake rotor 125.

As shown in FIG. 2A, the linear position estimate 258 may also be based on drag position adjustment 268. The drag position adjustment may be based on a previous adjustment of the position of the brake pad assembly based on a previously obtained instance of the drag by the controller 700. Additional details of the drag position adjustment 268 will be discussed below.

In embodiments, as part of linear position estimation process 254, controller 700 may perform (e.g., execute) one or more processes such as, but not limited to: obtaining (e.g., calculating or the like) a linear position estimate 258. The linear position estimate 258 may be calculated based on a measured position of the electric motor 520 along with other mechanical properties of the brake pad assembly 120. For example, in some embodiments, a kinematic relationship (e.g., a mechanical property) between the electric motor 520 and a pad position (e.g., a physical position of pads of the brake pad assembly 120) may be determined based on a rotational gear ratio of the actuator (e.g., of the actuator assembly 500) and a lead of the ball screw (e.g., of the screw mechanism 200). An example equation for calculating the linear position estimate 258 may be: LINEARPOSITION = 1000*(LEAD)*(MOTOR POSITION)/(G*2*pi) - OFFSET, where LEAD is the ball screw lead in mm/rev, MOTOR POSITION is the absolute measured position of the motor shaft of the electric motor 520 in radians, G is the overall gear ratio of the rotational actuator, and LINEARPOSITION is the linear position in mm, and OFFSET is a predetermined offset between the zero point in linear position and motor position. Other equations may also be used to calculate the linear position estimate 258 without departing from the scope of embodiments disclosed herein.

Once linear position estimate 258 is generated, linear position estimate 258 may be ingested into pad control process 260 along with linear position reference 256. In embodiments, the linear position reference 256 may represent a pre-defined length of an air gap (e.g., air gap/ position offset 230 shown in FIG. 2C) that should exist between the brake pad assembly 120 and the brake rotor 125. The linear position reference 256 may be preset into the controller 700 (e.g., into a memory of the controller 700) by a manufacturer of the brake assembly 10. Alternatively, the linear position reference 256 may be set by a driver of the vehicle via the chassis controller of the vehicle. Other ways of obtaining of the linear position reference 256 may also be used without departing from the scope of embodiments disclosed herein.

In embodiments, as part of pad position control process 260, controller 700 may perform (e.g., execute) one or more processes such as, but not limited to: controlling a pad position of the bake pad assembly 120 (e.g., controlling a physical position of pad/brake pads of the brake pad assembly 120). For example, in some embodiments, the pad position may be controlled using a cascading Proportional-Integral-Derivative (PID) control technique (e.g., similar to PID control techniques used in controlling steering angle in a power steering system. Linear position and linear velocity (e.g., of the electric motor 520) may be used, along with a refernce linear position, as inputs to obtain a motor torque output.

In embodiments, an error (difference) between position reference and measured may used with a standard PID controller to calculate a reference linear velocity. This linear velocity reference may cascade to a second control loop. The linear velocity reference and measured linear velocity may be sent through a second standard PID control loop to finally generate the motor torque value. This method advantageously provides stability and tuning as compared to a non-cascaded PID controller.

Additionally, lash and friction compensation logic may be used to determine (e.g., calculate) a correlation between the motor torque (e.g., of electric motor 520) and a wheel drag torque of the wheel onto which the brake rotor 125 is attached.

Other techniques and/or processes may also be used to control the pad position (e.g., as part of pad position control process 260) without departing from the scope of embodiments disclosed herein.

Linear position estimate 258 and linear position reference 256 may be ingested into pad position control process 260 to generate position control torque 262. The position control torque may be a value representative of a current motor torque being produced by electric motor 520. More specifically, position control torque 262 may be a motor torque required to maintain a current position (e.g., linear position) of the brake pad assembly 120.

As shown in FIG. 2A, position control torque 262 may be ingested into drag monitor process 264 to determine whether the brake assembly 10 is currently producing any drag, and to determine whether any produced drag violates a pre-defined and/or pre-set safety threshold. In embodiments, the pre-defined and/or pre-set safety threshold may vary from vehicle-to-vehicle and may vary based on one or more vehicle safety standards.

In particular, as part of drag monitor process 264, the position control torque 262 may first be filtered to obtain a moving average of the position control torque 262. For example, controller 700 may be constantly (e.g., continuously at a predetermined/pre-set interval) obtaining instances of the position control torque 262 as the vehicle is in motion. An average of these instances of the position control torque 262 over a predetermined/pre-set amount of time may be obtained. The predetermined/pre-set amount of time may be any amount of time (e.g., 300-400 milliseconds, or any suitable calibratable time interval) set by a manufacturer of the brake assembly 10 and/or vehicle.

In embodiments, the instances of the position control torque 262 may also be filtered based to exclude moments where a driver of the vehicle is actually providing a brake command to the brake assembly 10 (e.g., when the driver is executing a braking of the vehicle). For example, instances of the position control torque 262 calculated during receipt of the braking commands/instructions from the driver may be ignored and/or excluded from the calculations to obtain the a moving average of the position control torque 262 by the controller 700 as part of drag monitor process 264.

The controller 700 then, as part of drag monitor process 264, compares the moving average of the position control torque 262 to one or more predetermined thresholds (e.g., the above-discussed safety threshold, a safe performance range, a target performance threshold and/or value, and/or the like) and causes one or more actions based on a result of the comparisons.

For example, if the moving average of the position control torque 262 exceeds the safety threshold, the drag monitor process 264 may generate a drag fault flag 266 to alert the driver of the vehicle (e.g., via a digital or analog dashboard and/or the infotainment system of the vehicle, or the like). The drag monitor process 264 may also cause the brake assembly 10 to enter a safety mode (e.g., a safe state) where the brake pad assembly 120 is retained (e.g., placed) in a consistently open position with no contact against the brake rotor 125. In such safety mode, the brake assembly 10 may be unusable until reset by the driver, a technician, or a manufacturer. As a result, occurrence of thermal runaway may advantageously be mitigated.

As another example, if the moving average of the position control torque 262 is within a safe range but does not (e.g., fails to) meet the target performance threshold and/or value (e.g., there is drag but not enough to go over the safety threshold of the brake assembly 10), the controller 700 may cause the electric motor 520 to move the brake pad assembly 120 away from the brake rotor 125 to increase the air gap (e.g., air gap/ position offset 230 shown in FIG. 2C) between the brake pad assembly 120 and the brake rotor 125. The amount the brake pad assembly 120 is adjusted (e.g., moved) in the linear direction (e.g., 290 of FIGS. 2B and 2C) is recorded as drag position adjustment 268, which is provided back to and used in linear position estimation process 254 to result in a more accurate generation of the linear position estimate 258. As a result, any drag generated by the brake assembly 10 may advantageously be eliminated.

Other thresholds and actions may be utilized as part of drag monitor process 264 without departing from the scope of embodiments disclosed herein. For example, if there is no drag detected, no actions will be taken by controller 700 to control the brake pad assembly 120 (e.g., via electric motor 520).

Any of the processes illustrated using the second set of shapes (shown in FIG. 2A) may be performed, in part or whole, by digital processors (e.g., central processors, processor cores, etc.) that execute corresponding instructions (e.g., computer code/software) of controller 700. Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components of the controller 700 such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Turning to FIGS. 3A-3B, flowcharts illustrating methods for monitoring and controlling drag between a brake rotor and a brake pad assembly of a brake assembly in accordance with one or more embodiments are shown. The methods may be performed, for example, by controller 700 of the brake assembly 10 of FIG. 1 (and/or by a chassis controller of the vehicle not shown herein).

Starting with FIG. 3A, at Operation 300 and as discussed above in reference to FIG. 2A, a drag between a brake rotor and a brake pad assembly of a brake assembly (e.g., an EMB system, or the like) may be obtained while a vehicle (namely, the ignition of the vehicle) having the brake assembly is powered on.

Turning first to FIG. 3B, to obtain the drag in Operation 300 of FIG. 2A, Operations 310 through 314 of FIG. 3B may be performed.

In particular, at Operation 310 of FIG. 3B and as discussed above in reference to FIG. 2A (namely, in refernce to the descriptions related to linear position estimation process 254 of FIG. 2A), the controller 700 may obtain an estimated linear position of the brake pad assembly using a motor position and an initial position offset of the motor. In embodiments, the estimated linear position of the brake pad assembly may also be based on a drag position adjustment made to the brake pad assembly to decrease a drag generated by the brake pad assembly (e.g., whether any drag exists between the brake pad assembly and the brake rotor).

At Operation 312, and as discussed above in reference to FIG. 2A (namely, in refernce to the descriptions related to pad position control process 260 of FIG. 2A), the controller 700 may obtain a position control torque of the motor using the estimated linear position and a linear position reference value of the brake pad assembly.

At Operation 314, and as discussed above in reference to FIG. 2A (namely, in refernce to the descriptions related to drag monitor process 264 of FIG. 2A), the controller 700 may use the position control torque (e.g., instances of the position control torque generated at a pre-set/predetermined interval) to determine whether any drag is being generated by the brake pad assembly (e.g., whether any drag exists between the brake pad assembly and the brake rotor).

Turning back to FIG. 3A, at Operation 302 and as discussed above in reference to FIG. 2A (namely, in refernce to the descriptions related to drag monitor process 264 of FIG. 2A), the controller 700 may control an actuator assembly of the brake assembly to adjust a position of the brake pad assembly based on the drag obtained in Operation 300.

Any vehicle according to certain exemplary embodiments of the present disclosure may be identical, or substantially similar to, vehicle 800 shown in FIG. 4. The vehicle 800 may be any passenger or commercial automobile such as a hybrid vehicle, an electric vehicle, or any other type vehicles. FIG. 4 is a schematic view of a vehicle 800 including a steering system and a brake assembly 860 (e.g., the brake assembly 10 discussed above in reference to FIG. 1) according to an exemplary embodiment of the present disclosure. The vehicle 800 may include a steering system 810 for use in a vehicle. The steering system 810 can allow a driver or operator of the vehicle 800 to control the direction of the vehicle 800 or road wheels 830 of the vehicle 800 through the manipulation of a steering wheel 820. The steering wheel 820 is operatively coupled to a steering shaft (or steering column) 822. The steering wheel 820 may be directly or indirectly connected with the steering shaft 822. For example, the steering wheel 820 may be connected to the steering shaft 822 through a gear, a shaft, a belt and/or any connection means. The steering shaft 822 may be installed in a housing 824 such that the steering shaft 822 is rotatable within the housing 824.

The road wheels 830 may be connected to knuckles, which are in turn connected to tie rods. The tie rods are connected to a steering assembly 832. The steering assembly 832 may include a steering actuator motor 834 and steering rods 836. The steering rods 836 may be operatively coupled to the steering actuator motor 834 such that the steering actuator motor 834 is adapted to move the steering rods 836. The movement of the steering rods 836 controls the direction of the road wheels 830 through the knuckles and tie rods.

One or more sensors 840 may be configured to detect position, angular displacement or travel 825 of the steering shaft 822 or steering wheel 820, as well as detecting the torque of the angular displacement. The sensors 840 provide electric signals to a controller 850 indicative of the angular displacement and torque 825. The controller 850 sends and/or receives signals to/from the steering actuator motor 834 to actuate the steering actuator motor 834 in response to the angular displacement 825 of the steering wheel 820.

In the steer-by-wire steering system, the steering wheel 820 may be mechanically isolated from the road wheels 830. For example, the steer-by-wire system has no mechanical link connecting the steering wheel 825 from the road wheels 830. Accordingly, the steer-by wire steering system may comprise a feedback actuator or steering feel actuator 828 comprising an electric motor which is connected to the steering shaft or steering column 822. The feedback actuator or steering feel actuator 828 provides the driver or operator with the same “road feel” that the driver receives with a direct mechanical link.

Although the embodiment illustrated in FIG. 4 shows the vehicle 800 having the steer-by-wire steering system, the vehicle 800 may alternatively have a mechanical steering system without departing from embodiments disclosed herein. The mechanical steering system typically includes a mechanical linkage or a mechanical connection between the steering wheel 820 and the road wheels 830. In the mechanical steering system, the steering actuator motor 834 includes an electric motor to provide power to assist the movement of the road wheels 830 in response to the operation of the driver or a control signal of the controller 850. Accordingly, the electric motor can be used as the steering actuator motor 834 or can be included in the feedback actuator or steering feel actuator 828.

Although the example embodiments have been described in detail, it should be understood that various changes, substitutions and alterations can be made herein without departing from the spirit and scope of the present disclosure as defined by the appended claims.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. An electromechanical brake (EMB) system comprising:
a brake rotor configured to be rotatable with a wheel of a vehicle;
a brake pad assembly configured to be engageable with the brake rotor;
an actuator assembly comprising an electric motor configured to mechanically move the brake pad assembly toward or away from the brake rotor; and
an electronic control unit (ECU) coupled to the actuator assembly, the ECU comprising a processor coupled to a memory that stores instructions that when executed by the processor causes the processor to perform operations for monitoring and controlling drag between the brake rotor and the brake pad assembly, and the operations comprising:
obtaining, while the vehicle is in motion, a drag between the brake rotor and the brake pad assembly; and
controlling the actuator assembly to adjust a position of the brake pad assembly, relative to the brake rotor, based on the drag.

2. The EMB system of claim 1, wherein the drag is based on a position control torque required for the electric motor to maintain a current position of the brake pad assembly relative to the brake rotor.

3. The EMB system of claim 2, wherein obtaining the drag comprises:
obtaining a position of the electric motor and an initial position offset of electric motor; and
using the position of the electric motor and the initial position offset of electric motor to obtain an estimated linear position of the brake pad assembly.

4. The EMB system of claim 3, wherein obtaining the drag further comprises:
obtaining the position control torque using the estimated linear position of the brake pad assembly and a linear position reference value of the brake pad assembly.

5. The EMB system of claim 4, wherein the linear position reference value is preset by a manufacturer of the EMB system or by a driver of the vehicle.

6. The EMB system of claim 4, wherein obtaining the position control torque using the estimated linear position and the linear position reference value comprises use of lash and friction compensation logic to determine a correlation between a torque applied on the electric motor and a wheel drag of the vehicle.

7. The EMB system of claim 3, wherein the estimated linear position of the brake pad assembly is further based on a drag position adjustment performed by the actuator assembly, the drag position adjustment being based on a previous adjustment of the position of the brake pad assembly based on a previously obtained instance of the drag by the ECU.

8. The EMB system of claim 1, wherein the position of the brake pad assembly, relative to the brake rotor, is adjusted to mitigate occurrence of thermal runaway when a brake caliper of the EMB system comprises high residual drag as a result of the brake pad assembly being in constant contact with the brake rotor.

9. The EMB system of claim 1, wherein controlling the actuator assembly to adjust the position of the brake pad assembly based on the drag comprises:
in a first instance where the drag violates a safety threshold, causing the EMB system to enter a safe state where the brake pad assembly is placed into a continuously open position;
in a second instance where the drag exceeds a predetermined threshold that is lower than the safety threshold, causing the actuator assembly to increase a gap between the brake pad assembly and the brake rotor; and
in a third instance where the drag is below the predetermined threshold, causing the actuator assembly to maintain a current position of the brake pad assembly relative to the brake rotor.

10. The EMB system of claim 1, wherein controlling the actuator assembly to adjust the position of the brake pad assembly based on the drag comprises:
determining that the drag is within a safe operating range but fails to meet a predetermined performance target of the EMB system; and
causing the actuator assembly to increase a gap between the brake pad assembly and the brake rotor to eliminate the drag.

11. A method for monitoring and controlling drag between a brake rotor and a brake pad assembly of an electromechanical brake (EMB) system, the method being executed by an electric control unit (ECU) of the EMB system and comprising:
obtaining, while the vehicle is in motion, a drag between the brake rotor and the brake pad assembly; and
controlling the actuator assembly to adjust a position of the brake pad assembly, relative to the brake rotor, based on the drag,
wherein the brake rotor is configured to be rotatable with a wheel of a vehicle,
wherein the brake pad assembly is configured to be engageable with the brake rotor,
wherein the EMB system further comprises an actuator assembly comprising an electric motor configured to mechanically move the brake pad assembly toward or away from the brake rotor, and
wherein the ECU is coupled to the actuator assembly to mechanically control the actuator assembly.

12. The method of claim 11, wherein the drag is based on a position control torque required for the electric motor to maintain a current position of the brake pad assembly relative to the brake rotor.

13. The method of claim 12, wherein obtaining the drag comprises:
obtaining a position of the electric motor and an initial position offset of electric motor; and
using the position of the electric motor and the initial position offset of electric motor to obtain an estimated linear position of the brake pad assembly.

14. The method of claim 13, wherein obtaining the drag further comprises:
obtaining the position control torque using the estimated linear position of the brake pad assembly and a linear position reference value of the brake pad assembly.

15. The method of claim 14, wherein the linear position reference value is preset by a manufacturer of the EMB system or by a driver of the vehicle.

16. The method of claim 14, wherein obtaining the position control torque using the estimated linear position and the linear position reference value comprises use of lash and friction compensation logic to determine a correlation between a torque applied on the electric motor and a wheel drag of the vehicle.

17. The method of claim 13, wherein the estimated linear position of the brake pad assembly is further based on a drag position adjustment performed by the actuator assembly, the drag position adjustment being based on a previous adjustment of the position of the brake pad assembly based on a previously obtained instance of the drag by the ECU.

18. The method of claim 11, wherein the position of the brake pad assembly, relative to the brake rotor, is adjusted to mitigate occurrence of thermal runaway when a brake caliper of the EMB system comprises high residual drag as a result of the brake pad assembly being in constant contact with the brake rotor.

19. The method of claim 11, wherein controlling the actuator assembly to adjust the position of the brake pad assembly based on the drag comprises:
in a first instance where the drag violates a safety threshold, causing the EMB system to enter a safe state where the brake pad assembly is placed into a continuously open position;
in a second instance where the drag exceeds a predetermined threshold that is lower than the safety threshold, causing the actuator assembly to increase a gap between the brake pad assembly and the brake rotor; and
in a third instance where the drag is below the predetermined threshold, causing the actuator assembly to maintain a current position of the brake pad assembly relative to the brake rotor.

20. The method of claim 11, wherein controlling the actuator assembly to adjust the position of the brake pad assembly based on the drag comprises:
determining that the drag is within a safe operating range but fails to meet a predetermined performance target of the EMB system; and
causing the actuator assembly to increase a gap between the brake pad assembly and the brake rotor to eliminate the drag.
